(19) United States
(12) Patent Application Publication
(10) Pub. No.: US 2025/0057730 A1
(43) Pub. Date: Feb. 20, 2025

(54) CONTAINER HAVING A MULTI-AXIAL ROTATION ASSEMBLY

(71) Applicant: Holly Gonzalez, Fresh Meadows, NY (US)

(72) Inventor: Holly Gonzalez, Fresh Meadows, NY (US)

(21) Appl. No.: 18/449,744

(22) Filed: Aug. 15, 2023

(51) Int. Cl. A61J 11/00; A61J 9/00

(52) U.S. Cl. CPC A61J 11/004; A61J 9/00

(57) ABSTRACT

The disclosure relates to a container having a multi-axial rotation assembly that facilitates a distribution of liquid at a variety of angles.

### BACKGROUND

When bottle-feeding a baby, a conventionally shaped bottle is held at a horizontal angle allowing the baby to feed. If milk or formula does not fill the entire nipple of the bottle when feeding, the baby may gulp an excess amount of air resulting in gas, reflux, and fussiness. Angled bottles may promote semi-upright feed positions while directing milk or formula into the nipple. As such, the amount of air the baby gulps is reduced. However, the fixed angle of these bottles generally limits the positions in which, for example, a parent can comfortably hold the bottle during feeding. Further, the fixed angles of these bottles require the parent to constantly readjust the position of the bottle to coincide with the baby's movements while feeding and ensure that the nipple is adequately filled with milk or formula.

### SUMMARY

The disclosure relates generally to containers, and more particularly, a bottle having a multi-axial rotation assembly that facilitates the distribution of the contents of the bottle at a variety of angles.

In one aspect, the disclosed technology relates to a container assembly. In one or more cases, the container assembly includes a container, a delivery apparatus, and a collar. In one or more cases, the container includes a hollow body having an open end disposed opposite a closed end. In one or more cases, the delivery apparatus includes a spherical body and a nipple coupled together. Each of the spherical body and the nipple includes an aperture. A portion of the spherical body is configured to be positioned within the open end of the container. In one or more cases, the collar has a tubular body sized to house a portion of the delivery apparatus therein. The collar is configured to be removably coupled to a portion of the open end of the container, thereby securing the portion of the delivery apparatus within the container. The nipple of the delivery apparatus is configured to reside outside of the collar. The delivery apparatus is configured to rotate in a multi-axial direction about the collar.

In another aspect, the disclosed technology relates to a multi-axial rotation assembly. In one or more cases, the multi-axial rotation assembly includes a delivery apparatus and a collar. The delivery apparatus includes a spherical body and a nipple coupled together. Each of the spherical body and the nipple includes an aperture. A portion of the spherical body is configured to be positioned within an open end of a container. The collar has a tubular body sized to house a portion of the delivery apparatus therein. The collar is configured to be removably coupled to a portion of the open end of the container.

In another aspect, the disclosed technology relates to a multi-axial rotation assembly. In one or more cases, the multi-axial rotation assembly includes a delivery apparatus and a collar. The delivery apparatus includes a spherical body and a nipple coupled together. Each of the spherical body and the nipple includes an aperture. A portion of the spherical body is configured to be positioned within an open end of a container. The collar includes an annular body forming a hollow center sized to house a portion of the delivery apparatus therein. The annular body comprises a groove configure to interface with an open end of the container.

The summary of the disclosure is given to aid understanding of containers, and in particular bottles, and not with an intent to limit the disclosure. The present disclosure is directed to a person of ordinary skill in the art it should be understood that various aspects and features of the disclosure may advantageously be used separately in some instances, or in combination with other aspects and features of the disclosure in other instances. Accordingly, it is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of embodiments of the present disclosure and therefore do not limit the scope of the present disclosure.

FIG. 1 illustrates a perspective view of an example container assembly.

FIG. 2 illustrates an exploded perspective view of the example container assembly of FIG. 1.

FIG. 3 illustrates a top view of an example body of an example delivery apparatus of FIG. 2.

FIG. 4A illustrates a perspective view of another example body of an example delivery apparatus. FIG. 4B illustrates a top view of the example body of the example delivery apparatus of FIG. 4A.

FIGS. 5A and 5B illustrate exploded perspective views of example coupling features of the delivery apparatus of FIG. 2.

FIG. 6A illustrates a top view of an example delivery apparatus collar. FIG. 6B illustrates a cross-sectional view of the example delivery apparatus interface of FIG. 6A coupled with an example container.

FIG. 7A illustrates a cross-sectional view of an example container. FIG. 7B illustrates a side view of the example container of FIG. 7A.

FIGS. 8A and 8B illustrate a multi-axial rotation of an example delivery apparatus.

FIG. 9 illustrates a perspective view of another example delivery apparatus.

FIG. 10 illustrates an exploded perspective view of another example delivery apparatus.

FIG. 11 illustrates an exploded perspective view of another example delivery apparatus.

### DETAILED DESCRIPTION

The following discussion omits or only briefly describes conventional features of containers, which are apparent to those skilled in the art. It is noted that various embodiments are described in detail with reference to the drawings, in which like reference numerals represent like drawing elements throughout the figures. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. Moreover, the drawings are not to scale and are intended for use in conjunction with the explanations in the following detailed description. The objectives and advantages of the claimed subject matter will become more apparent from the following detailed description of these embodiments in connection with the accompanying drawings.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof.

Embodiments of the disclosure relate generally to containers, and more particularly, to a bottle having a multi-axial rotation assembly that facilitates the distribution of contents at a variety of angles. Embodiments that provide a multi-axial rotation assembly are described below with reference to the figures.

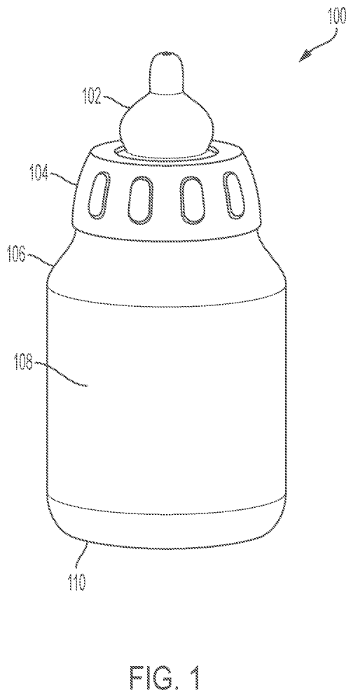

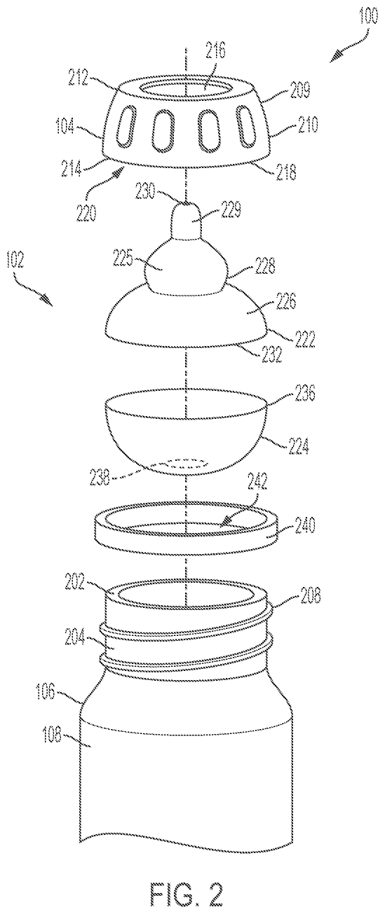

FIG. 1 illustrates a perspective view of an example container assembly 100. FIG. 2 illustrates an exploded perspective view of the container assembly 100 of FIG. 1. In one or more cases, the container assembly 100 may include a container 106, a collar 104, and a delivery apparatus 102 removably coupled to one another. The container assembly 100 is configured to facilitate the distribution of content stored within the inner volume of the container assembly 100. For example, the container assembly 100 may distribute a liquid, such as, but not limited to, milk, formula, and the like.

The container 106 has a body 108 having a closed end 110, as illustrated in FIG. 1, and an open end 202, as illustrated in FIG. 2, disposed opposite the closed end 110. The container 106, and in particular, the body 108, is sized to contain a liquid within the volume of the body 108. In some cases, the body 108 may have a cylindrical shape. In other cases, the body 108 may have an ergonomic shape that provides portions of the container 106 that are easier to grasp. The open end 202 of the body 108 includes a neck 204 configured to be removably coupled with the collar 104, such that the collar 104 may be fastened to the container 106 and be removed from the container 106. For example, the neck 204 may have a threaded portion 208 configured to mate with a threaded portion of the collar 104, such that the collar 104 and container 106 may be fastened together by rotating the collar 104 onto the neck 204 of the body 108. In one or more cases, the diameter of the neck 204 is smaller than the diameter of the body 108. In one or more other cases, the diameter of the neck 204 is the same size or is larger than the diameter of the body 108.

The collar 104 has a tubular body 210 having a first end 212 disposed opposite a second end 214. The first end 212 includes a first opening 216, and the second end 214 includes a second opening 218, allowing a portion of the delivery apparatus 102 to pass therethrough. The volume of the collar 104 is sized such that at least a portion of the delivery apparatus 102 is configured to reside within the area of the tubular body 210. In one or more cases, the outer surface 209 of the tubular body 210 tapers inwards from the second end 214 to the first end 212, such that the diameter of the first end 212 is smaller than the diameter of the second end 214. In one or more other cases, the outer surface 209 is cylindrically shaped, such that the diameters of the first and second ends 212 and 214 are the same. In one or more cases, the collar 104 includes one or more gripping portions 220 configured to aide a user when fastening and unfastening the collar 104 and container 106 by providing additional surface textures to improve the user's grip when rotating the collar 104. The gripping portions 220 may be circumferentially disposed around the outer surface 209 of the body 210. A gripping portion may be a rigid body that protrudes from the outer surface 209 of the body 210 or is recessed from the outer surface 209 of the body 210. In one or more cases, all the gripping portions 220 may protrude from the outer surface 209 of the body 210. In one or more other cases, all the gripping portions 220 may be recessed from the outer surface 209 of the body 210. In one or more other cases, one or more gripping portions 220 may be recessed from the outer surface 209 of the body 210, and one or more gripping portions 220 may protrude from the outer surface 209 of the body 210.

The delivery apparatus 102 includes a first body 222 and a second body 224 coupled to one another and configured to swivel within a portion of the collar 104 and a portion of the container 102. In one or more cases, the delivery apparatus 102 may rest on a portion of a delivery apparatus collar 240. The delivery apparatus collar 240 may be an annular body having a hollow center 242 and is sized to fit over a portion of the open end 202 of the neck 204. The diameter of the hollow center 242 may be smaller than the diameter of the open end 202 of the neck 204. As such, the delivery apparatus 102 may rest on a portion of the delivery apparatus collar 240. The delivery apparatus collar 240 prevents the delivery apparatus 102 from falling into the body 108 of the container 106. In one or more cases, the delivery apparatus collar 240 is removably coupled to the neck 204 of the container 106. The ability to remove the delivery apparatus collar 240 from the neck 204 allows a user to sanitize the delivery apparatus collar 240 more thoroughly. Additionally, the delivery apparatus collar 240, collar 104, and the delivery apparatus 102 may be sized to couple to a neck of a conventional container, thereby providing a universal fit. In one or more other cases, the deliver apparatus collar 240 is integrated into the neck 204 of the container 106, thereby providing a unibody construction.

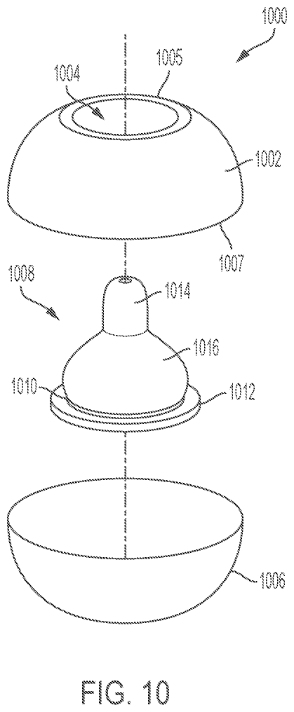

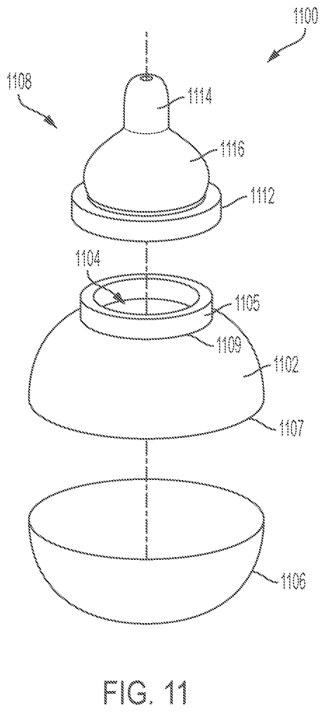

The first body 222 includes a rigid portion 226 coupled with a nipple 228. In some cases, the nipple 228 and rigid portion 226 may be coupled to one another such that the nipple 228 is fixed and not removable from the rigid portion 226. In other cases, as further described with respect to the delivery apparatus 1000 illustrated in FIG. 10 and the delivery apparatus 1100 illustrated in FIG. 11, the nipple, such as nipple 1008 or 1108, may be removably coupled from the rigid portion, such as a first body 1002 or first body 1102, respectively, such that the nipple may be replaced.

The nipple 228 includes a base 225 and stem 229. In one or more cases, the base 225 may have a bulbous shape, such that the surface of the base 225 curves towards the surface of the rigid portion 226, thereby forming a bulbous shape. In one or more other cases, the base 225 may have a gradient effect such that the height of the surface of base 225 smoothly transitions to the same or substantially similar height of the surface of the rigid portion 226. The stem 229 may have a substantially cylindrical shape that tapers from the base 225 to the distal end of the stem 229. The stein 229 may include an aperture 230 disposed on the distal end of the stein 229, in which liquid may pass. The nipple 228 may be made of a flexible material, such as, but not limited to, silicon, latex, or other like rubber materials. For example, the nipple 228 may be made of a material that simulates the function of a breast during breast-feeding. The rigid portion 226 is formed in a hemispherical shape having a hollow body in which an annular end 232 is disposed opposite the nipple 228. The rigid portion 226 may be made of a rigid or semi-rigid material, such as, but not limited to, plastic and the like.

The second body 224 is formed in a hemispherical shape having a hollow body. The second body 224 may be made of a rigid or semi-rigid material, such as, but not limited to, plastic and the like. The second body 224 includes an annular end 236 configured to interface with the annular end 232 of the rigid portion 226. When the annular end 232 of the first body 222 and the annular end 236 of the second body 224 are interfaced with one another, the first body 222 and the second body 224 form a substantially spherical shape. The hollow portions of the first body 222 and the second body 224 form a cavity therein.

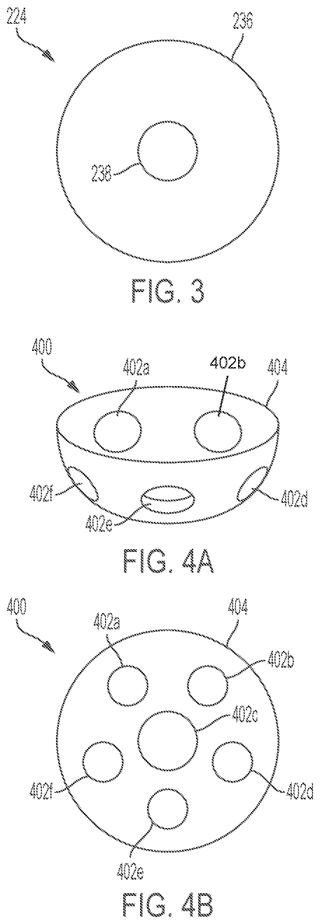

In one or more cases, the second body 224 includes at least one aperture, such as aperture 238, as illustrated in FIG. 2 and FIG. 3, and the apertures 402, as illustrated in FIG. 4A and FIG. 4B. As illustrated, the aperture 238 may be positioned on any portion of the second body 224. For example, the aperture 238 may be centered within the second body 224, when viewed from a top perspective as illustrated in FIG. 3. The aperture 238 may be sized to receive liquid from the container 106. FIG. 4A illustrates a perspective view of another second body 400 having multiple apertures, such as apertures 402a-402f, and 413 illustrates a top view of the second body 400. Apertures, such as apertures 402a, 402b, 402d, 402e, and 402f, may be radially disposed around the second body 400. An aperture, such as aperture 402c may be centered within the second body 400, when viewed from a top perspective as illustrated in FIG. 4B. In one or more other cases, the apertures 402a-402f may be randomly positioned around the second body 400. In one or more cases, the apertures 402a-402f may have the same diameter as each other. In one or more other cases, the apertures 402a-402f may have a variety of sizes. For example, apertures 402a, 402b, 402d, 402e, and 402f may have the same size diameter, and the central aperture 402c may have a diameter larger than the diameters of apertures 402a, 402b, 402d, 402e, and 402f. The increased number of apertures within the second body 400 may be configured to allow more liquid to pass from the container 106 to the delivery apparatus 102 than the singular aperture 238 of the second body 224. It is noted that although the second body 400 is illustrated as having a plurality of apertures, it should be understood that the second body 400 includes one or more of the same or similar features as those described with respect to the second body 224. For example, an annular end 404 of the second body 400 may interface with the annular end 232 of the first body 222, such as the first body 222 and second body 400 form a substantially spherical shape. Accordingly, a description of the same or similar features is noted repeated.

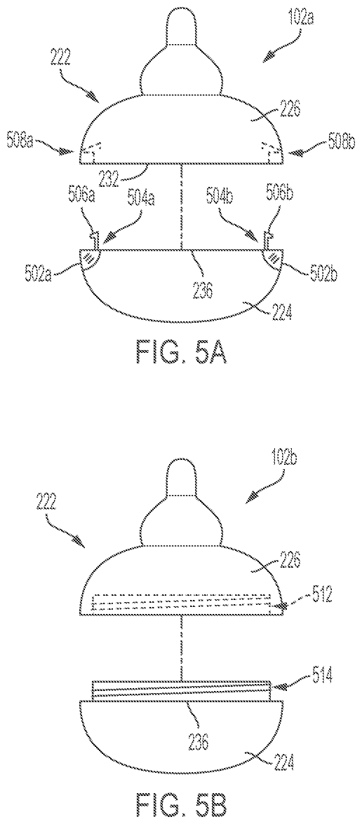

The first body 222 and the second body 224 are configured to be removably coupled to one another. In one or more cases, the first body 222 and the second body 224 may be coupled together by snapping one of the first body 222 or second body 224 into the other body. For example, as illustrated in FIG. 5A, one or more interlocking tabs, such as tabs 504a and 504b may protrude from the annular end 232 of the first body 222 and be configured to interlock with respective recessed areas, such as recessed areas 508a and 508b. The recessed areas may be positioned within the rigid portion 226 of the first body 222. The tabs 504a and 504b may be flexible yet maintain their respective forms when positioned in an unflexed position. The respective distal ends 506a and 506b of the tabs 504a and 504b may have tapered surfaces, configured to guide the tabs 504a and 504b to be positioned within the rigid portion 226. For instance, as the first body 222 and the second body 224 are being coupled to one another, the tapered surface of distal end 506a and the tapered surface of distal end 506b contact the annular end 232 of the rigid portion 226. As the tabs 504a and 504b are inserted within the rigid portion 226, the tapered surfaces of distal ends 506a and 506b guide the respective tabs 504a and 504b to flex inwards. When the tabs 506a and 506b are aligned with the recessed areas 508a and 508b, the tabs 506a and 506b flex outwards such that a portion of the distal end 506a is inserted within recessed area 508a and a portion of the distal end 506b is inserted within recessed area 508b, thereby coupling the first body 222 and the second body 224.

In one or more cases, the second body 224 includes one or more depression members, such as depression members 502a and 502b. The depression members 502a and 502b may be aligned with tabs 506a and 506b, respectively. The depression members 502a and 502b may be recessed within the second body 224, providing surfaces for a user to compress the second body 224. For instance, as the depression members 502 and 502b are pressed towards one another, the tabs 506a and 506b move inwards such that distal ends 506a and 506b disengage from the respective recessed areas 508a and 508b, thereby decoupling the first body 222 and the second body 224.

It is noted that although FIG. 5A illustrates that the first body 222 includes two recessed areas 508a and 508b and that the second body 224 includes two tabs 506a and 506b, it should be understood that the first body 222 may include one recessed area that extends around the circumference of the first body 222, thereby forming an annular recessed area. Moreover, it should be understood that the second body 224 may include one tab that extends around the circumference of the second body 224, thereby forming a singular tab that is circumferentially disposed on the annular end 236 of the second body 224. Further, it is noted that although FIG. 5A illustrates that the first body 222 includes recessed areas 508a and 508b and that the second body 224 includes depression members 502a and 502b and tabs 506a and 506b, it should be understood that the first body 222 may include depression members 502a and 502b and tabs 506a and 506b and that the second body 224 may include recessed areas 508a and 508b.

In one or more other cases, the first body 222 and the second body 224 may be removably coupled to one another by rotating one of the first body 222 or second body 224 onto the other. For example, as illustrated in FIG. 5B, the second body 224 includes a threaded body 514 that protrudes from the annular end 236, and the first body 222 includes a threaded body 512 positioned within the rigid portion 226 of the first body 222. The threaded bodies 512 and 514 are configured to mate with one another as one of the first body 222 or second body 224 is rotated onto the other. It is noted that although FIG. 5B illustrates that the first body 222 includes the threaded body 512 and the second body 224 includes the threaded body 514, it should be understood that that the second body 224 includes threaded body 512 and the first body 222 includes the threaded body 514.

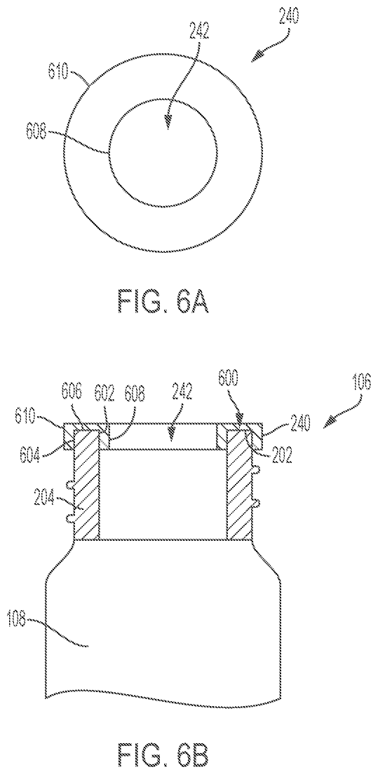

FIG. 6A illustrates a top view of the example delivery apparatus collar 240 of FIG. 2. FIG. 6B illustrates a cross-sectional view of the example delivery apparatus collar 240 of FIG. 6A coupled with the example container 106. As illustrated in FIG. 6A, the delivery apparatus collar 240 may be an annular body that includes an inner surface 608 and an outer surface 610. The inner surface 608 of the delivery apparatus collar 240 defines the hollow center 242. The inner surface 608 may formed as having one of a variety of edges, such as, but not limited to, a coved edge, a square edge, a based edge, a beveled edge, and the like. The delivery apparatus collar 240 may include a groove 600 disposed between the inner surface 608 and the outer surface 610. The groove 600 may be defined by a top wall 606, a side wall 602, and a side wall 604, and sized to interface with the open end 202 of the neck 204. For example, when the groove 600 is coupled to the neck 204, a portion of the neck 204 may reside within the top wall 606, side wall 602, and side wall 604, as illustrated in FIG. 6B.

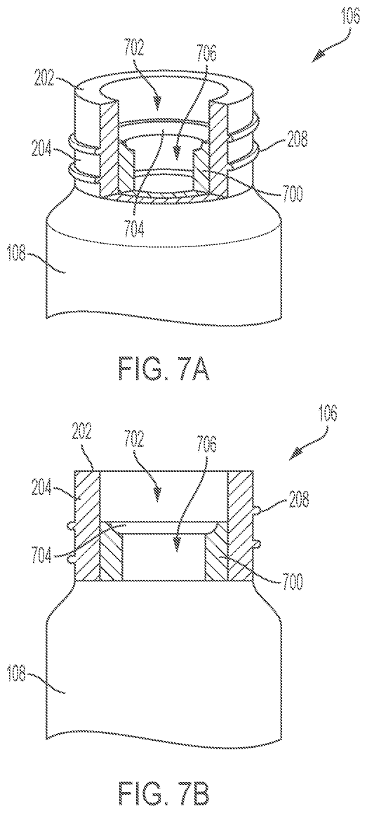

FIG. 7A illustrates a cross-sectional view of the container 106. FIG. 7B illustrates a side view of the container 106 of FIG. 7A. In one or more cases, the neck 204 of the container 106 includes an inner channel 700 having a diameter 706 that is smaller than the diameter 702 of the portion of the neck 204 that does not include the inner channel 700. In such configuration, the delivery apparatus collar 240 may not be utilized in the configuration illustrated in FIGS. 7A and 7B. A proximal end 704 of the inner channel 700 is configured to interface with a portion of the delivery apparatus 102. For example, a portion of the second body 224 of the delivery apparatus 102 may interface with the proximal end 704 of the inner channel 700 and position the delivery apparatus 102 within the neck 204 of the container 106. As such, the delivery apparatus 102 may rotate in a multi-axial direction about the inner channel 700. In one or more cases, the proximal end 704 of the inner channel 700 may be formed as one of a variety of edges, such as, but not limited to, a coved edge, a square edge, a based edge, a beveled edge, and the like. The edge of the proximal end 704 may further aid in positioning the delivery apparatus 102 within the neck 204.

In one or more other cases, neither the inner channel 700 nor the delivery apparatus collar 240 are utilized. Rather, the circumference of the delivery apparatus 102 and the circumference of the interior surface of the neck 204 may be sized such that a portion of the delivery apparatus 102 may be positioned within a portion of the neck 204 without falling into the body 108 of the container 106. In one or more cases, the circumference of the delivery apparatus 102 may be sized such that a portion of the delivery apparatus 102 may be positioned to snuggly fit within a portion of an opening of a conventionally container, such as the opening of a conventional baby-bottle. Further, the collar 104 may be sized to be removably coupled to necks of conventional baby-bottles having a variety of diameters. That is, the delivery apparatus 102 and collar 104 may provide a multi-axial rotation assembly sized and configured to have a universal fit.

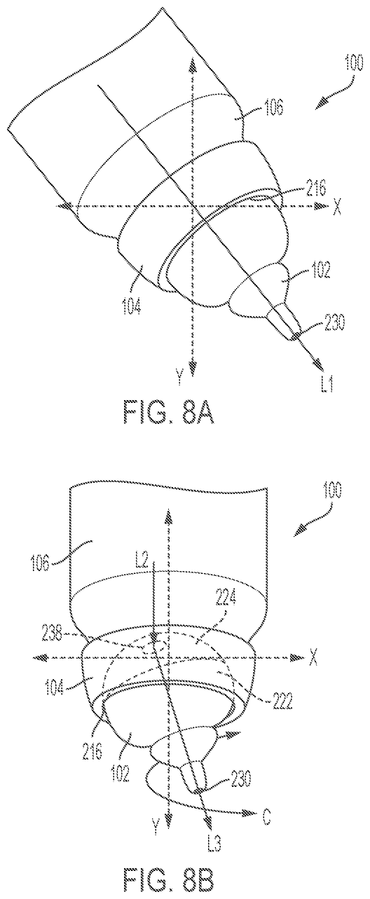

To bottle-feed a baby via the container assembly 100, a liquid, such as formula, is poured through the open end 202 of the container 106 and fills at least a portion of the container 106. The delivery apparatus 102 may be configured such that the first body 222 and the second body 224 are coupled together forming a substantially spherical shape. The delivery apparatus 102 is inserted into at least a portion of the neck 204 of the container 106, such that the nipple 228 is positioned outside of the container 106 and the one or more apertures, such as aperture 238 is facing the body 108 of the container 106. The collar 104 is placed over at least a portion of the delivery apparatus 102 and a portion of the neck 204 of the container 106. The nipple 228 may be positioned to extend beyond the first opening 216 of the collar 104. The collar 104 may be coupled to at least a portion of the neck 204 of the container 106 such that the delivery apparatus 102 is secured within the collar 104 and the container 106. The delivery apparatus 102 may be secured such that the delivery apparatus 102 can rotate in a multi-axial direction (e.g., direction C as illustrated in FIG. 8B) within a portion of the collar 104. The delivery apparatus 102 may snuggly fit within the collar 104 and container 106 such that liquid may enter aperture 238 of the delivery apparatus 102 and exit the aperture 230 of the nipple 228 without leaking through the first opening 216 of the collar 104. For instance, as illustrated in FIG. 8A, when the container assembly 100 is positioned at a downward angle, fluid within the container 106 may flow in direction L1 and exit the aperture 230 of the delivery apparatus 102. That is, fluid may pass from the body 108 through aperture 238 of the delivery apparatus 102 and fill at least a portion of the volume defined by the first body 222 and second body 224. The fluid may exit the aperture 230 of the nipple 228 as, for example, a baby feeds.

As a user, such as a baby, and/or another user, such as a parent, adjusts positions, the container assembly 100 may also adjust to coincide with the movements of one or both users, as illustrated in FIGS. 8A and 8B. For instance, a parent and baby may begin feeding such that the container assembly 100 is positioned for the formula to flow in direction L1, as illustrated in FIG. 8A. If, for example, the parent moves the container 106 to another position, such as the position illustrated in FIG. 8B, the delivery apparatus 102 may maintain and/or rotate in direction C to coincide with the position of the feeding baby in direction L3. As such, the formula may continue to flow, for example, in direction L2, from the container 106 into the delivery apparatus 102, thereby ensuring that the nipple 228 is adequately filled.

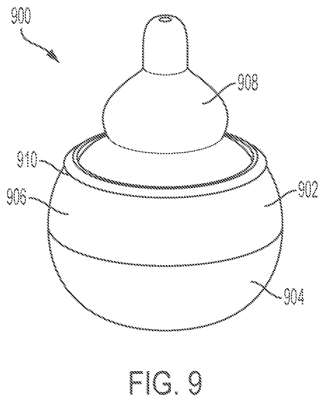

FIG. 9 illustrates a perspective view of another example delivery apparatus 900. The delivery apparatus 900 includes a first body 902 removably coupled to a second body 904. The second body 904 includes one or more of the same or similar features of the second body 224 or the second body 400, and as such, a description of such features is not repeated. The first body 902 includes a rigid portion 906 and nipple 908. The rigid portion 906 and the nipple 908 include one or more of the same or similar features of the rigid portion 226 and the nipple 228, and as such, a description of such features is not repeated. The first body 902 may include a protrusion 910 disposed on the outer surface of the rigid portion 906. The protrusion 910 may be a rigid body that extends from the outer surface of the rigid portion 906. During multi-axial rotation of the delivery apparatus 900 within, for example, the collar 104, the protrusion 910 may be configured to contact a portion of the first end 212 of the collar 104, thereby limiting the degree of rotation of the delivery apparatus 900 within the collar 104. As such, when the protrusion 910 contacts a portion of the first end 212 of the collar 104, the delivery apparatus 900 is prevented from over-rotating and pinching a portion of the nipple 908 within the collar. In one or more cases, the protrusion 910 may be disposed around the entire circumference of the rigid portion 906. In one or more other cases, the protrusion 910 may be a series of protrusions intermittently disposed around the circumference of the rigid portion 906.

FIG. 10 illustrates an exploded perspective view of another example delivery apparatus 1000. The delivery apparatus 1000 includes a nipple 1008, a first body 1002, and a second body 1006. The first body 1002 and the second body 1006 may be removably coupled to one another. The second body 1006 includes one or more of the same or similar features of the second body 224 or the second body 400, and as such, a description of such features is not repeated. The first body 1002 includes one or more of the same or similar features of the rigid portion 226 and rigid portion 906, and as such a description of such features is not repeated. The first body 1002 is distinguishable from the rigid portion 226 first body 222 and the rigid portion 906 of the first body 902 in that the nipple 1008 may be removably coupled with the first body 1002. As such, the nipple 1008 may be replaced with another nipple when, for example, the nipple 1008 becomes worn, unsanitary, damaged, or missing.

The first body 1002 may include an aperture 1004 within a distal end 1005 of the first body 1002. The nipple 1008 may include a base 1016 and a stem 1014 that include the same or similar features as those described for the base 225 and stem 229 of nipple 228, and as such, a description of those features is not repeated. The base 1016 may include a flange 1012 that forms a recess 1010 circumferentially disposed around the nipple 1008. The recess 1010 is sized to snuggly fit within the aperture 1004 of the first body 1002. A portion of the bulbous area of the base 1016 and the flange 1012 is configured to fit around a portion of the distal end 1005 that forms the aperture 1004 when the recess 1010 interfaces with the portion of the distal end 1005 that forms the aperture 1004. The portion of the bulbous area of the base 1016 and the flange 1012 may be configured to prevent the nipple 1008 from being unintentionally uncoupled from the first body 1002 during feeding. Further, the portion of the bulbous area of the base 1016 and the flange 1012 may be configured to fit around the portion of the distal end 1005 that forms the aperture 1004 such that liquid within the delivery apparatus 1000 does not leak out of the area defined by the recess 1010 and the portion of the distal end 1005 that forms the aperture 1004. It is noted that, although FIG. 10 illustrates the base 1016 of the nipple 1008 as having a bulbous shape, the base 1016 may be formed in a shape having a gradient effect such that the height of the surface of base 1016 smoothly transitions to the same or substantially similar height of the surface of the distal end 1005 of the first body 1002.

FIG. 11 illustrates an exploded perspective view of another example delivery apparatus 1100. The delivery apparatus 1100 includes a nipple 1108, a first body 1102, and a second body 1106. The first body 1102 and the second body 1106 may be removably coupled to one another. The second body 1106 includes one or more of the same or similar features of the second body 224 or the second body 400, and as such, a description of such features is not repeated. The first body 1102 includes one or more of the same or similar features of the rigid portion 226 and rigid portion 906, and as such a description of such features is not repeated. The first body 1102 is distinguishable from the rigid portion 226 of the first body 222 and the rigid portion 906 of the first body 902 in that the nipple 1108 may be removably coupled with the first body 1102. As such, the nipple 1108 may be replaced with another nipple when, for example, the nipple 1108 becomes worn, unsanitary, damaged, or missing.

The first body 1102 may include a neck 1105 that extends from a distal end 1109 of the first body 1102. The neck 1105 may be a rigid body that protrudes from the distal end 1109 of the first body 1102. The neck 1105 may include an aperture 1104 sized to allow liquid to pass from the interior area of the first body 1102 and the second body 1106 and into the nipple 1108. The nipple 1108 may include a base 1116 and a stem 1114 that include the same or similar features as those described for the base 225 and stem 229 of nipple 228, and as such, a description of those features is not repeated. The base 1116 may include a collar 1112 configured to interface with the neck 1105 of the first body 1102. The collar 1112 may be sized to snuggly fit over the neck 1105, such that the nipple 1108 is prevented from being unintentionally uncoupled from the first body 1102.

The foregoing is provided for the purpose of illustrating, explaining, and describing embodiments of this disclosure. While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure.

What is claimed is:

1. A container assembly comprising:
a container comprising a hollow body having an open end disposed opposite a closed end,
a delivery apparatus comprising a spherical body and a nipple coupled together, each of the spherical body and the nipple comprising an aperture, and a portion of the spherical body is configured to be positioned within the open end of the container; and
a collar having a tubular body sized to house a portion of the delivery apparatus therein, the collar is configured to be removably coupled to a portion of the open end of the container, thereby securing the portion of the delivery apparatus within the container,
wherein the nipple of the delivery apparatus is configured to reside outside of the collar, and
wherein the delivery apparatus is configured to rotate in a multi-axial direction about the collar.

2. The container assembly of claim 1, wherein the spherical body comprises a first body and a second body removably coupled to one another, the first body and second body each form in a hemispherical shape.

3. The container assembly of claim 2, wherein the second body comprises at least one aperture configured to allow liquid to pass from the hollow body of the container to the spherical body of the delivery apparatus.

4. The container assembly of claim 2, wherein one of the first body or second body comprises tabs and the other of the first body or second body comprises recesses, and wherein a tab is configured to interlock with a recess.

5. The container assembly of claim 2, wherein a proximal end of the first body and a proximal end of the second body each comprise threaded bodies configured to rotate and fasten the first body and second body to one another.

6. The container assembly of claim 2, wherein the first body comprises a protrusion extending from the outer surface of the first body and being disposed around at least a portion of the circumference of the first body.

7. The container assembly of claim 2, wherein the first body comprises a rigid material and the nipple is comprised of a flexible material disposed on a distal end of the first body.

8. The container assembly of claim 2, wherein the first body comprises an aperture disposed on a distal end of the first body, wherein the nipple comprises a recessed portion configured to snuggly fit within the aperture of the first body.

9. The container assembly of claim 2, wherein the first body comprises a neck protruding from a distal end of the first body, wherein the nipple comprises a second collar configured to snuggly fit over the neck of the first body

10. The container assembly of claim 1, wherein the nipple is configured to be removably coupled to the spherical body.

11. The container assembly of claim 1, wherein the container comprises a neck disposed on the open end of the hollow body, and wherein a diameter of the neck is smaller than a diameter of the spherical body.

12. The container assembly of claim 11, wherein the neck comprises an inner channel configured to interface with the spherical body and prevent the delivery apparatus from being disposed within the hollow body of the container.

13. The container assembly of claim 1, further comprising a second collar having an annular body forming a hollow center,
wherein the container comprises a neck disposed on the open end of the hollow body, and
wherein the annular body of the second collar comprises a groove configured to interface with a portion of the neck of the container.

14. A multi-axial rotation assembly comprising:
a delivery apparatus comprising a spherical body and a nipple coupled together, each of the spherical body and the nipple comprising an aperture, and a portion of the spherical body is configured to be positioned within an open end of a container; and
a collar having a tubular body sized to house a portion of the delivery apparatus therein, the collar is configured to be removably coupled to a portion of the open end of the container.

15. The multi-axial rotation assembly of claim 14, wherein the spherical body comprises a first body and a second body removably coupled to one another, the first body and second body each form in a hemispherical shape.

16. The multi-axial rotation assembly of claim 15, wherein the second body comprises at least one aperture.

17. The multi-axial rotation assembly of claim 15, wherein the first body comprises a protrusion extending from the outer surface of the first body and being disposed around at least a portion of the circumference of the first body.

18. The multi-axial rotation assembly of claim 15, wherein the first body comprises a rigid material and the nipple is comprised of a flexible material disposed on a distal end of the first body.

19. The multi-axial rotation assembly of claim 14, wherein the nipple is configured to be removably coupled to the spherical body.

20. A multi-axial rotation assembly comprising:
a delivery apparatus comprising a spherical body and a nipple coupled together, each of the spherical body and the nipple comprising an aperture, and a portion of the spherical body is configured to be positioned within an open end of a container; and
a collar having an annular body forming a hollow center sized to house a portion of the delivery apparatus therein, wherein the annular body comprises a groove configure to interface with an open end of the container.
